(19) United States
(12) Patent Application Publication
(10) Pub. No.: US 2020/0263629 A1
(43) Pub. Date: Aug. 20, 2020

(54) PISTON FOR INTERNAL COMBUSTION ENGINE

(71) Applicant: HITACHI AUTOMOTIVE SYSTEMS, LTD., Hitachinaka-shi, Ibaraki (JP)

(72) Inventors: Yuto HIGASA, Hadano-shi, Kanagawa (JP); Toshiyuki FUNAHASHI, Zama-shi, Kanagawa (JP)

(73) Assignee: HITACHI AUTOMOTIVE SYSTEMS, LTD., Hitachinaka-shi, Ibaraki (JP)

(21) Appl. No.: 16/647,949

(22) PCT Filed: Sep. 5, 2018
(86) PCT No.: PCT/JP2018/032793

§ 371 Date: Mar. 17, 2020

(30) Foreign Application Priority Data
Sep. 21, 2017 (JP) 2017-181781

(51) Int. Cl. F02F 3/00; F02F 3/02

(52) U.S. Cl. CPC F02F 3/0076; F02F 2200/06; F05C 2201/021; F02F 3/027

(57) ABSTRACT

A piston for an internal combustion engine includes a piston head portion, a pair of piston skirt portions, and a pair of side-wall portions. Each of the side-wall portions includes a pin boss portion having a piston pin hole, and is located between the pair of piston skirt portions. There are set a first axis corresponding to a center longitudinal axis of the piston, a second axis corresponding to an axis of the piston pin holes, and a reference plane corresponding to a plane that passes through the first axis and is orthogonal to the second axis. In a cross section of the side-wall portion being parallel to both of the first axis and the second axis, a distance between the reference plane and an outer peripheral surface of the side-wall portion in the second axis direction gradually increases from a side of the piston head portion toward an intermediate portion of the side-wall portion in the direction of the first axis and gradually decreases from the intermediate portion toward a side opposite to the piston head portion.

### TECHNICAL FIELD

The present invention relates to a piston for an internal combustion engine.

### BACKGROUND ART

An internal combustion engine includes a piston. The piston includes a piston head portion, a pair of piston skirt portions, and a pair of side-wall portions. Each of the side-wall portions includes a pin boss portion having a piston pin hole, and is located between the pair of piston skirt portions. For example, in a piston disclosed in Patent Literature 1, when there are set a first axis corresponding to a center longitudinal axis of the piston, a second axis corresponding to an axis of the piston pin holes, and a reference plane corresponding to plane that passes through the first axis and is orthogonal to the second axis, in a cross section of the side-wall portion parallel to both of the first axis and the second axis, a distance between the reference plane and an outer peripheral surface of the side-wall portion in the second axis direction gradually decreases from a near side toward a far side with respect to the piston head portion in the first axis direction.

### CITATION LIST

### Patent Literature

PTL 1: JP 2010-509529 A

### SUMMARY OF INVENTION

### Technical Problem

With regard to the piston disclosed in Patent Literature 1, there is room for improvement in strength of the piston.

### Solution to Problem

In a piston for an internal combustion engine according to one embodiment of the present invention, it is preferred that, in the cross section of the side-wall portion described above, a distance between the reference plane and the outer peripheral surface of the side-wall portion in the second axis direction gradually increases from a side of the piston head portion toward an intermediate portion of the side-wall portion in the direction of the first axis and gradually decreases from the intermediate portion toward a side opposite to the piston head portion.

Therefore, with the piston for an internal combustion engine according to one embodiment of the present invention, the strength of the piston can be improved.

### BRIEF DESCRIPTION OF DRAWINGS

FIG. 1 is a view for illustrating a piston according to a first embodiment coupled to a small end portion of a connecting rod through intermediation of a piston pin, as viewed from a longitudinal direction of the piston pin.

FIG. 2 is a perspective view for illustrating the piston according to the first embodiment, as viewed from a side of a piston crown surface.

FIG. 3 is a view for illustrating a part between a pin boss portion and a skirt portion in an outer periphery of the piston according to the first embodiment, as viewed from a direction orthogonal to a first axis of the piston.

FIG. 4 is a view for illustrating the piston according to the first embodiment, as viewed from a direction of the first axis of the piston and from a side opposite to the piston crown surface.

FIG. 5 is a view for illustrating the skirt portion in the outer periphery of the piston according to the first embodiment, as viewed from the direction orthogonal to the first axis of the piston.

FIG. 6 shows a cross section of the piston according to the first embodiment taken along a plane that is parallel to the first axis of the piston and is parallel to the longitudinal direction of the piston pin.

FIG. 7 is a perspective view for illustrating a piston according to a second embodiment, as viewed from the side of the piston crown surface.

FIG. 8 is a view for illustrating the piston according to the second embodiment, as viewed from the direction of the first axis of the piston and from the side opposite to the piston crown surface.

FIG. 9 is a view for illustrating the skirt portion in the outer periphery of the piston according to the second embodiment, as viewed from the direction orthogonal to the first axis of the piston.

FIG. 10 shows a cross section of the piston according to the second embodiment taken along a plane that is parallel to the first axis of the piston and is parallel to the longitudinal direction of the piston pin.

FIG. 11 is a perspective view for illustrating a piston according to a third embodiment, as viewed from the side of the piston crown surface.

FIG. 12 is a view for illustrating the piston according to the third embodiment, as viewed from the direction of the first axis of the piston and from the side opposite to the piston crown surface.

FIG. 13 is a view for illustrating the skirt portion in the outer periphery of the piston according to the third embodiment, as viewed from the direction orthogonal to the first axis of the piston.

FIG. 14 shows a cross section of the piston according to the third embodiment taken along a plane that is parallel to the first axis of the piston and is parallel to the longitudinal direction of the piston pin.

FIG. 15 shows a cross section of a piston according to a fourth embodiment taken along a plane that is parallel to the first axis of the piston and is parallel to the longitudinal direction of the piston pin.

FIG. 16 is a view for illustrating a part of a piston according to another embodiment, as viewed from the direction of the first axis of the piston and from the side opposite to the piston crown surface.

FIG. 17 is a view for illustrating a part of a piston according to another embodiment, as viewed from the direction of the first axis of the piston and from the side opposite to the piston crown surface.

### DESCRIPTION OF EMBODIMENTS

A description is made below of embodiments of the present invention with reference to the drawings.

### First Embodiment

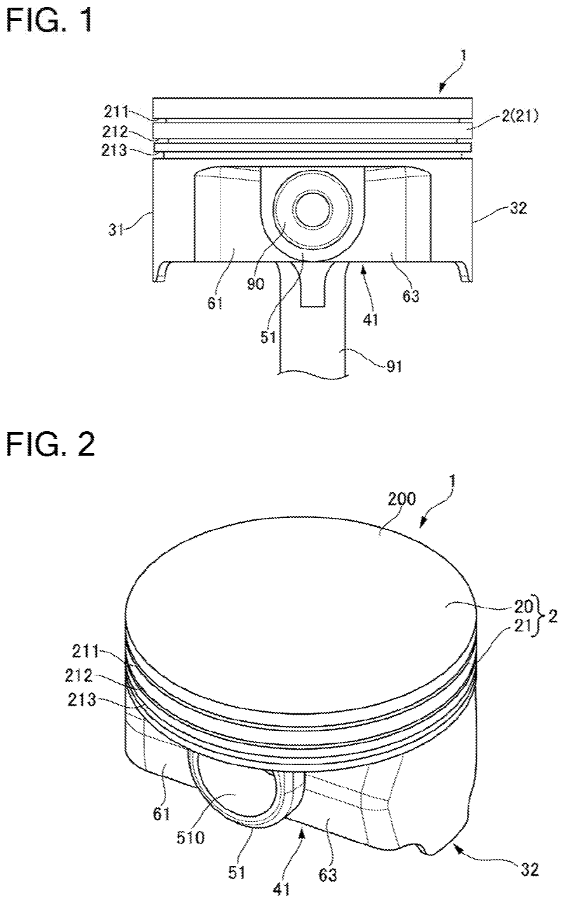

First, a configuration is described. An internal combustion engine (engine) of this embodiment is a 4-stroke gasoline engine, and is used as a driving force source for a vehicle such as an automobile. A piston 1 for an engine is accommodated in a cylinder having a cylindrical shape so as to be reciprocally movable. As illustrated in FIG. 1, the piston 1 is coupled to a small end portion of a connecting rod 91 through intermediation of a piston pin 90. A large end portion of the connecting rod 91 is coupled to a crankshaft. The piston 1 is cast from an aluminum alloy as a material. A main material of the piston 1 may be, for example, iron. The piston 1 has a bottomed cylindrical shape, and integrally includes a piston head portion 2, skirt portions 31 and 32, and side-wall portions 41 and 42.

As illustrated in FIG. 2, the piston head portion 2 integrally includes a crown portion 20 and a land portion 21. The land portion 21 has, in an outer peripheral surface thereof, three annular piston ring grooves 211, 212, and 213. Piston rings are provided in those grooves 211, 212, and 213, respectively. A cross section of the piston head portion 2 passing through an entire circumference of (any one of) the piston ring grooves 211, 212, and 213, in other words, a cross section of the piston head portion 2 taken along a plane orthogonal to a moving direction of the piston 1 inside the cylinder has a substantially circular shape. An axis (extending along the moving direction) that passes through a center of the circle and is orthogonal to the cross section is referred to as “first axis 71” of the piston 1. In the following, a plurality of axes including the first axis 71 are suitably defined, and a direction in which each axis extends is referred to as “axis direction”. The crown portion 20 is a plate-like part (plate-like portion) being located on one side of the piston head portion 2 in the first axis direction and extending in a direction orthogonal to the first axis 71. The crown portion 20 has, on one side in the first axis direction, a piston crown surface (top surface) 200. The piston crown surface 200 is opposed to a combustion chamber. The land portion 21 is a tubular part (tubular portion) extending from an outer peripheral side of the crown portion 20 toward another side in the first axis direction. As illustrated in FIG. 6, a radius (distance from the first axis 71) of an inner peripheral surface 210 of the land portion 21 gradually increases from one side toward another side in the first axis direction. In a cross section taken along a plane parallel to the first axis 71, the inner peripheral surface 210 has a linear shape.

As illustrated in FIG. 4, the skirt portions 31 and 32 and the side-wall portions 41 and 42 are connected to the piston head portion 2 on a side opposite to the piston crown surface 200 in the first axis direction and extend from the piston head portion 2 toward another side in the first axis direction. A hollow space is defined on an inner peripheral side of the skirt portions 31 and 32 and the side-wall portions 41 and 42. The skirt portions 31 and 32 are located on both sides in a radial direction with respect to the first axis 71 of the piston 1 (hereinafter simply referred to as “radial direction”). As illustrated in FIG. 4, the first skirt portion 31 has an outer peripheral surface 310 on a radially outer side thereof and has an inner peripheral surface 311 on a radially inner side thereof. The outer peripheral surface 310 has a curved surface shape extending along an inner peripheral surface of the cylinder. The surfaces 310 and 311 are substantially parallel to each other and extend in the first axis direction. The second skirt portion 32 also has the same configuration. The side-wall portions 41 and 42 are provided in a pair on both sides of the piston 1 in the radial direction. The first side-wall portion 41 is located between the first skirt portion 31 and the second skirt portion 32 in a direction around the first axis 71 (hereinafter, simply referred to as “circumferential direction”, and is connected (coupled) to both of the skirt portions 31 and 32. The second side-wall portion 42 also has the same configuration. The first side-wall portion 41 includes a pin boss portion 51 and apron portions 61 and 63. The second side-wall portion 42 includes a pin boss portion 52 and apron portions 62 and 64.

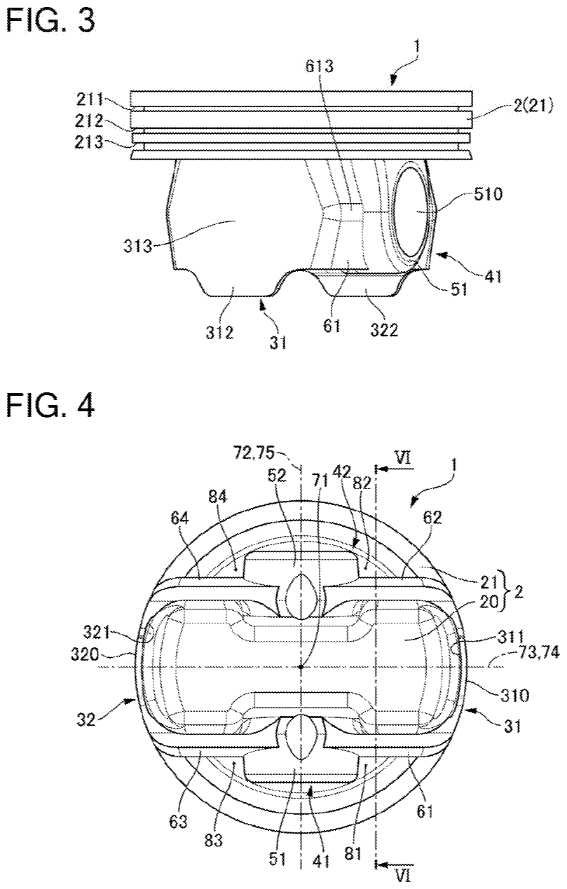

As illustrated in FIG. 2 and FIG. 3, the first pin boss portion 51 has a first piston pin hole 510. The hole 510 has a cylindrical shape, and extends in the radial direction of the piston 1 through the pin boss portion 51. One end portion of the piston pin 90 is inserted and fitted into the hole 510. A cross section of the hole 510 taken along a plane orthogonal to a longitudinal direction of the hole 510 has a substantially circular shape. An axis (axis of hole 510) which passes through a center of the circle and is parallel to the longitudinal direction of the hole 510 is referred to as “second axis 72” of the piston 1. Moreover, an axis that is orthogonal to the first axis 71 when viewed from a direction of the second axis 72 and is orthogonal to the second axis 72 when viewed from a direction of the first axis 71 is referred to as “third axis 73” (see FIG. 4). The first pin boss portion 51 has a tubular shape surrounding the hole 510. As illustrated in FIG. 2 and FIG. 6, on one side in the first axis direction with respect to the second axis 72, the pin boss portion 51 extends in the first axis direction to be connected to the piston head portion 2. On another side in the first axis direction with respect to the second axis 72, the pin boss portion 51 has a semi-cylindrical shape along the hole 510. Both end surfaces of the pin boss portion 51 in the second axis direction each have a planar shape extending orthogonal to the second axis 72. The second pin boss portion 52 also has the same configuration as the first pin boss portion 51. The second pin boss portion 52 is opposed to the first pin boss portion 51 in the second axis direction. An axis of a second piston pin hole 520 matches with the second axis 72. Another end portion of the piston pin 90 is inserted and fitted into the second piston pin hole 520.

As illustrated in FIG. 4, the apron portions 61 to 64 connect (couple) the pin boss portions 51 and 52 and the skirt portions 31 and 32 to one another in the circumferential direction (in the third axis direction). The first apron portion 61 connects the first pin boss portion 51 and the first skirt portion 31 to each other. The second apron portion 62 connects the second pin boss portion 52 and the first skirt portion 31 to each other. The third apron portion 63 connects the first pin boss portion 51 and the second skirt portion 32 to each other. The fourth apron portion 64 connects the second pin boss portion 52 and the second skirt portion 32 to each other. As illustrated in FIG. 6, an outer peripheral surface 610 is formed on a radially outer side of the first apron portion 61, and an inner peripheral surface 611 is formed on a radially inner side. The surfaces 610 and 611 are substantially parallel to each other and extend along the third axis 73. The second to fourth apron portions 62 to 64 also have the same configuration. As illustrated in FIG. 4 to FIG. 6, a part of the first skirt portion 31 (extension portion 312) extends so as to project toward another side in the first axis direction with respect to the apron portions 61 and 62, and a part of the second skirt portion 32 (extension portion 322) extends so as to project toward another side in the first axis direction with respect to the apron portions 63 and 64. As illustrated in FIG. 4, space portions (cavities) 81 to 84 are defined between outer peripheral surfaces 610 to 640 of the apron portions 61 to 64 and the inner peripheral surface 210 of the land portion 21 in the second axis direction. As illustrated in FIG. 6, the space portions 81 to 84 are defined in regions overlapping with the land portion 21 and not overlapping with the crown portion 20 in the first axis direction.

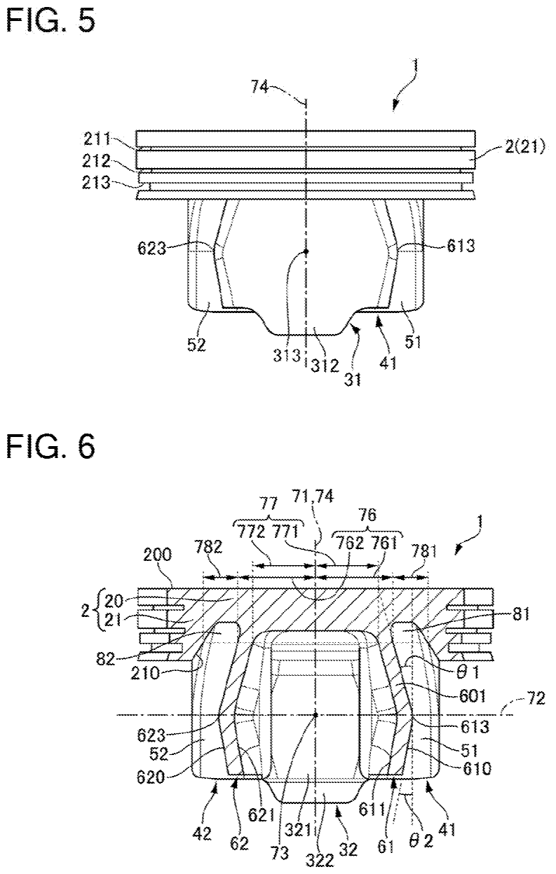

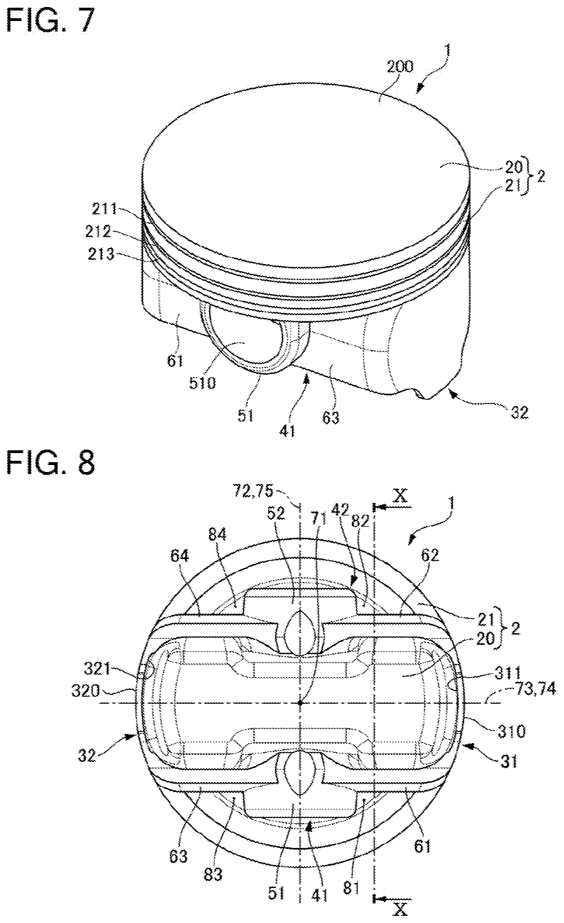

Now, details of shapes of the apron portions and the skirt portions are described. As illustrated in FIG. 5, a width of the skirt portion 31 in the circumferential direction gradually increases from one side in the first axis direction (side of the piston head portion 2) toward an intermediate portion 313 and gradually decreases from the intermediate portion 313 toward another side in the first axis direction (side opposite to the piston head portion 2). The width of the skirt portion 31 is maximum at the intermediate portion 313. The term “intermediate portion” as used herein does not mean a center portion (part located at a bisecting position in the first axis direction) but a freely selected part between both ends in the first axis direction. As illustrated in FIG. 3, the intermediate portion 313 is located at a position which is substantially the same as those of axes of the piston pin holes 510 and 520 (second axis 72) in the first axis direction, and overlaps with the piston pin holes 510 and 520. Both ends of the skirt portion 31 in the circumferential direction each have a linear shape on both sides in the first axis direction across the intermediate portion 313. The skirt portion 32 also has the same shape as the skirt portion 31.

A plane that passes through the first axis 71 and is orthogonal to the second axis 72 is referred to as “first reference plane 74” (see FIG. 4 and FIG. 6). As illustrated in FIG. 6, cross sections (side-wall cross sections) of the apron portions 61 and 62 which are parallel to both of the first axis 71 and the second axis 72 are referred to as “cross section 601” and “cross section 602”, respectively. In the cross section 601, a distance between the reference plane 74 and the outer peripheral surface 610 of the apron portion 61 in the second axis direction gradually increases from one side in the first axis direction (side of the piston head portion 2) toward the intermediate portion 613 and gradually decreases from the intermediate portion 613 toward another side in the first axis direction (side opposite to the piston head portion 2). Similarly, a distance between the reference plane 74 and the inner peripheral surface 611 of the apron portion 61 in the second axis direction gradually increases from one side in the first axis direction toward the intermediate portion 613 and gradually decreases from the intermediate portion 613 toward another side in the first axis direction. The intermediate portion 613 is located on another side in the first axis direction with respect to the center portion of the apron portion 61 in the first axis direction (part located at a position bisecting the apron portion 61 in the first axis direction). As the end of the apron portion 61 on one side in the first axis direction at the time of determining the center portion of the apron portion 61, there may be used, for example, an end of the outer peripheral surface 610 on one side in the first axis direction (connection portion with respect to the crown portion 20). As illustrated in FIG. 3, the intermediate portion 613 overlaps with the piston pin hole 510 in the first axis direction (as viewed from the third axis direction). Specifically, the intermediate portion 613 is located at substantially the same position as the axis of the piston pin hole 510 in the first axis direction.

As illustrated in FIG. 6, in the cross section 601, the gradual increase or decrease in the distance between the reference plane 74 and the outer peripheral surface 610 (and the inner peripheral surface 611) in the second axis direction along the first axis direction is synonymous with inclination of the outer peripheral surface 610 (and the inner peripheral surface 611) with respect to the reference plane 74. In this embodiment, in the cross section 601, the outer peripheral surface 610 and the inner peripheral surface 611 of the apron portion 61 each have a linear shape on both sides in the first axis direction across the intermediate portion 613. Therefore, as an angle of the inclination, an angle between (a straight line parallel to) the reference plane 74 and the outer peripheral surface 610 (and the inner peripheral surface 611) in the cross section 601 can be used as it is. An angle θ1 of the inclination on one side in the first axis direction with respect to the intermediate portion 613 is larger than an angle θ2 of the inclination on another side in the first axis direction with respect to the intermediate portion 613.

As illustrated in FIG. 6, at a freely selected position in the third axis direction, a distance 781 between the inner peripheral surface 210 of the land portion 21 and the outer peripheral surface 610 of the apron portion 61 in the second axis direction (a width of the space portion 81 in the second axis direction) gradually increases from one side toward another side in the first axis direction.

The apron portions 62 to 64 also have the same shape as the apron portion 61.

Next, actions and effects are described. At the time of actuation of the engine, the piston 1 receives, on the piston crown surface 200 thereof, combustion pressure generated in a combustion chamber to thereby reciprocally move inside the cylinder. The combustion pressure acts on the crown portion 20. At the time of movement of the piston 1 in the cylinder, due to inclination of the connecting rod 91, the skirt portions 31 and 32 are pressed against an inner wall of the cylinder and receive a reaction force (lateral force) in a direction toward a second reference plane 75. The second reference plane 75 is a plane that passes through the second axis 72 and is parallel to the first axis 71. With this, internal stress is generated in the skirt portions 31 and 32. The piston 1 may swing (swivel) about the piston pin 90 (second axis 72). The extension portions 312 and 322 of the skirt portions 31 and 32 have a function to suppress the swing. As separating away from the swing center, a displacement amount of the skirt portions 31 and 32 from the second reference plane 75 (toward the inner wall of the cylinder) due to the swing (inclination) of the piston 1 becomes larger. Thus, in the skirt portions 31 and 32, the lateral force (stress) becomes larger as separating away from the swing center while proceeding from a position corresponding to the second axis 72 in the first axis direction toward both end portions in the first axis direction.

In contrast, in the cross section 601 of the apron portion 61, a distance 761 between the first reference plane 74 and the outer peripheral surface 610 of the apron portion 61 in the second axis direction gradually increases from one side in the first axis direction (side of the piston head portion 2) toward the intermediate portion 613 and gradually decreases from the intermediate portion 613 toward another side in the first axis direction (side opposite to the piston head portion 2). Similarly, in the cross section 602 of the apron portion 62, a distance 762 between the first reference plane 74 and the outer peripheral surface 620 of the apron portion 62 in the second axis direction gradually increases from the one side in the first axis direction toward an intermediate portion 623 and gradually decreases from the intermediate portion 623 toward the another side in the first axis direction.

Thus, strength of the crown portion 20 can be improved. That is, at a freely selected position in the third axis direction, a distance 76 (=761+762) between the outer peripheral surface 610 of the apron portion 61 and the outer peripheral surface 620 of the apron portion 62 in the second axis direction gradually decreases from the intermediate portions 613 and 623 toward the side of the piston head portion 2 in the first axis direction. Accordingly, in the crown portion 20, a distance between a part at which the outer peripheral surface 610 of the apron portion 61 is connected and a part at which the outer peripheral surface 620 of the apron portion 62 is connected in the second axis direction becomes smaller. Support positions for the crown portion 20 by the apron portions 61 and 62 approach the first reference plane 74 (first axis 71). Thus, deformation of the crown portion 20 is suppressed, thereby being capable of improving the strength of the crown portion 20.

Moreover, strength of the skirt portion 31 can be improved. That is, the skirt portion 31 is supported, on both sides thereof in the circumferential direction, by the apron portions 61 and 62. When the support span is wide (when a width of the skirt portion 31 in the circumferential direction is large), a rigidity of the skirt portion 31 tends to decrease. When the support span is narrow (when a width of the skirt portion 31 in the circumferential direction is small), the rigidity of the skirt portion 31 tends to increase. The apron portions 61 and 62 extend in the third axis direction, and hence a width of the skirt portion 31 in the circumferential direction substantially corresponds to the distance 76 between the outer peripheral surface 610 of the apron portion 61 and the outer peripheral surface 620 of the apron portion 62 in the second axis direction. The width of the skirt portion 31 in the circumferential direction (distance 76) gradually decreases from the intermediate portion 313 (intermediate portions 613 and 623) toward one side (side of the piston head portion 2) in the first axis direction. That is, as proceeding toward the one side of the skirt portion 31 at which the displacement amount due to the swing of the piston 1 becomes larger, the support span of the skirt portion 31 is shortened. Thus, through suppression of deformation on the one side of the skirt portion 31 against the lateral force received from the inner wall of the cylinder to alleviate stress concentration due to the deformation, the strength can be improved. Meanwhile, the width of the skirt portion 31 in the circumferential direction (distance 76) gradually decreases from the intermediate portion 313 (intermediate portions 613 and 623) toward another side (side opposite to the piston head portion 2) in the first axis direction. That is, as proceeding toward the another side of the skirt portion 31 at which the displacement amount due to the swing of the piston 1 becomes larger, the support span of the skirt portion 31 is shortened. Thus, through the improvement in strength on the another side of the skirt portion 31 against the lateral force, excessive deformation at the end portion on the another side can be suppressed. With this, there is no need to provide additional thickness (for example, rib portion) to the end portion on the another side to ensure the rigidity, thereby also being capable of reducing the weight of the piston 1.

Moreover, the width of the skirt portion 31 in the circumferential direction (distance 76) gradually increases from one side (side of the piston head portion 2) toward the intermediate portion 313 in the first axis direction and gradually decreases from the intermediate portion 313 toward another side (side opposite to the piston head portion 2), thereby being capable of reducing hitting sounds of the piston 1. That is, the piston 1 may cause hitting sounds when the skirt portion 31 collides with the inner wall of the cylinder. When the skirt portion 31 has a small rigidity so that the skirt portion 31 is likely to deform at the time of the collision, the hitting sounds become smaller. As the width of the skirt portion 31 in the circumferential direction (support span of the skirt portion 31) gradually increases toward the intermediate portion 313 in the first axis direction, the skirt portion 31 is more likely to deform at the intermediate portion 313 and in the vicinity thereof, thereby being capable of reducing the hitting sounds of the piston 1.

The intermediate portion 313 (intermediate portions 613 and 623) overlaps with the piston pin holes 510 and 520 in the first axis direction. At the intermediate portion 313, the support span of the skirt portion 31 is the largest, and the rigidity is small. Meanwhile, the piston pin holes 510 and 520 include the swing center of the piston 1 (second axis 72). In the skirt portion 31, a position corresponding to the swing center in the first axis direction and a region in the vicinity thereof have a smaller displacement amount (from the second reference plane 75) due to the swing of the piston 1 than other regions. The intermediate portion 313 at which the support span of the skirt portion 31 is large and thus the rigidity is small overlaps with such a region that the displacement amount is small and thus a demand for improvement in rigidity is less than other regions. Thus, the piston 1 which is capable of improving the rigidity of the skirt portion 31 and 32 while reducing the hitting sounds of the piston 1, that is, has a well-balanced rigidity can be obtained. From the viewpoint described above, it is preferred that, as in this embodiment, the intermediate portion 313 (intermediate portions 613 and 623) be located as close as possible to the second axis 72 (further, located substantially at the same position) in the first axis direction.

The description with regard to the outer peripheral surfaces 610 and 620 similarly applies to the inner peripheral surfaces 611 and 621 of the apron portions 61 and 62. That is, in the cross section 601 of the apron portion 61, a distance 771 between the first reference plane 74 and the inner peripheral surface 611 of the apron portion 61 in the second axis direction gradually increases from one side in the first axis direction (side of the piston head portion 2) toward the intermediate portion 613 and gradually decreases from the intermediate portion 613 toward another side in the first axis direction (side opposite to the piston head portion 2). Similarly, in the cross section 602 of the apron portion 62, a distance 772 between the first reference plane 74 and the inner peripheral surface 621 of the apron portion 62 in the second axis direction gradually increases from the one side in the first axis direction toward the intermediate portion 623 and gradually decreases from the intermediate portion 623 toward the another side in the first axis direction. In other words, at a freely selected position in the third axis direction, a distance 77 (=771+772) between the inner peripheral surface 611 of the apron portion 61 and the inner peripheral surface 621 of the apron portion 62 in the second axis direction gradually decreases from the intermediate portions 613 and 623 toward one side (side of the piston head portion 2) and another side (side opposite to the piston head portion 2) in the first axis direction. Accordingly, in the crown portion 20, a distance between a part at which the inner peripheral surface 611 of the apron portion 61 is connected and a part at which the inner peripheral surface 621 of the apron portion 62 is connected in the second axis direction becomes smaller. With this, the strength of the crown portion 20 can be further improved. Moreover, with the distance 77 (support span of the skirt portion 31) being shortened as proceeding toward one side and another side in the first axis direction (at which the displacement amount due to the swing of the piston 1 becomes larger), the strength of the skirt portion 31 can be further improved. As the distance 77 (support span of the skirt portion 31) becomes longer as proceeding toward the intermediate portion 313 (at which the displacement amount due to the swing of the piston 1 becomes smaller), the hitting sounds of the piston 1 can be further reduced.

In the above, description is made of the example with the apron portions 61 and 62 and the skirt portion 31. However, also with regard to the apron portions 63 and 64 and the skirt portion 32, the same actions and effects can be attained with the same configuration.

The space portion 81 is defined between the outer peripheral surface 610 of the apron portion 61 and the inner peripheral surface 210 of the land portion 21 in the second axis direction. The thickness is reduced by the amount corresponding to the space portion 81, thereby being capable of reducing the weight of the piston 1. In the cross section 601 of the apron portion 61, the distance 761 between the first reference plane 74 and the outer peripheral surface 610 in the second axis direction gradually increases from the side of the piston head portion 2 toward the intermediate portion 613 in the first axis direction. In other words, the outer peripheral surface 610 of the apron portion 61 is biased toward the side of the first reference plane 74 as proceeding from the intermediate portion 613 toward the side of the piston head portion 2 in the first axis direction. Accordingly, the distance 781 between the outer peripheral surface 610 of the apron portion 61 and the inner peripheral surface 210 of the land portion 21 in the second axis direction can be set larger. With the distance 781 being set larger, a volume of the space portion 81 (thickness reduction amount) increases, thereby being capable of further reducing the weight of the piston 1. The distance 781 (width of the space portion 81 in the second axis direction) gradually increases from one side toward another side in the first axis direction. Accordingly, in a case of molding the space portion 81 with a casting mold, the mold can easily be removed toward another side in the first axis direction, thereby being capable of smoothly performing a mold removing step for the space portion 81.

The intermediate portion 613 of the apron portion 61 is located on a side opposite to the piston head portion 2 with respect to the center portion of the apron portion 61 in the first axis direction. Accordingly, as compared to a case in which the intermediate portion 613 is located on the side of the piston head portion 2 with respect to the center portion of the apron portion 61 in the first axis direction, the outer peripheral surface 610 of the apron portion 61 on the side of the piston head portion 2 can be more biased toward the side of the first reference plane 74, and hence the distance 781 (volume of the space portion 81) can easily be set larger.

In the cross section 601 of the apron portion 61, the outer peripheral surface 610 is inclined with respect to the first reference plane 74. The angle θ1 of the inclination on the side of the piston head portion 2 with respect to the intermediate portion 613 is larger than the angle θ2 of the inclination on the side opposite to the piston head 2 with respect to the intermediate portion 613. Accordingly, as compared to a case in which θ1 is smaller than θ2, the outer peripheral surface 610 on the side of the piston head portion 2 can be more biased toward the side of the first reference plane 74, thereby being capable of setting the distance 781 (volume of the space portion 81) to be larger.

In the cross section 601 of the apron portion 61, the inner peripheral surface 611 is inclined in the same direction as the outer peripheral surface 610 with respect to the reference plane 74. The surfaces 610 and 611 are inclined in the same direction, and hence a sharp change in thickness of the apron portion 61 in the second axis direction (thickness) is suppressed. Accordingly, stress concentration at the apron portion 61 can be suppressed. Specifically, the outer peripheral surface 610 and the inner peripheral surface 611 of the apron portion 61 are substantially parallel to each other. With this, a change in thickness of the apron portion 61 becomes smaller.

In the above, description is made of the example with the apron portion 61. However, also with regard to the apron portions 62 to 64, the same actions and effects can be attained with the same configuration.

### Second Embodiment

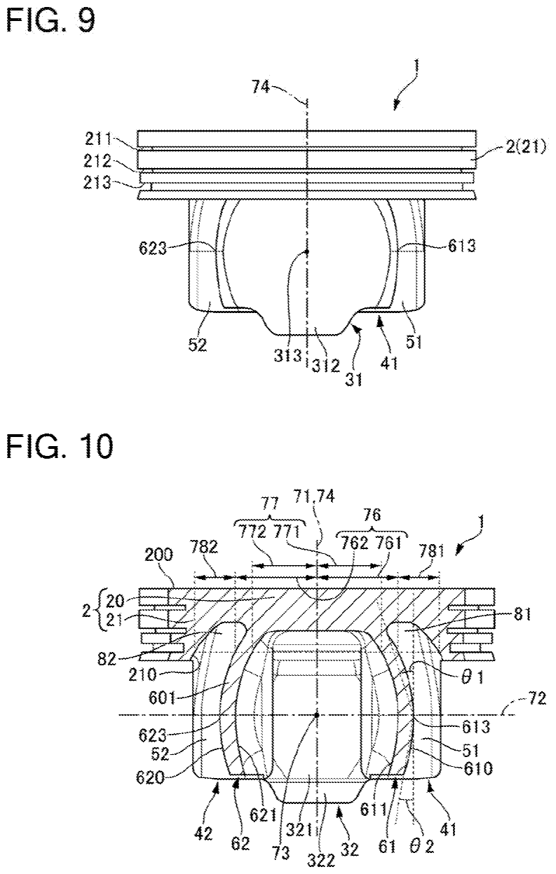

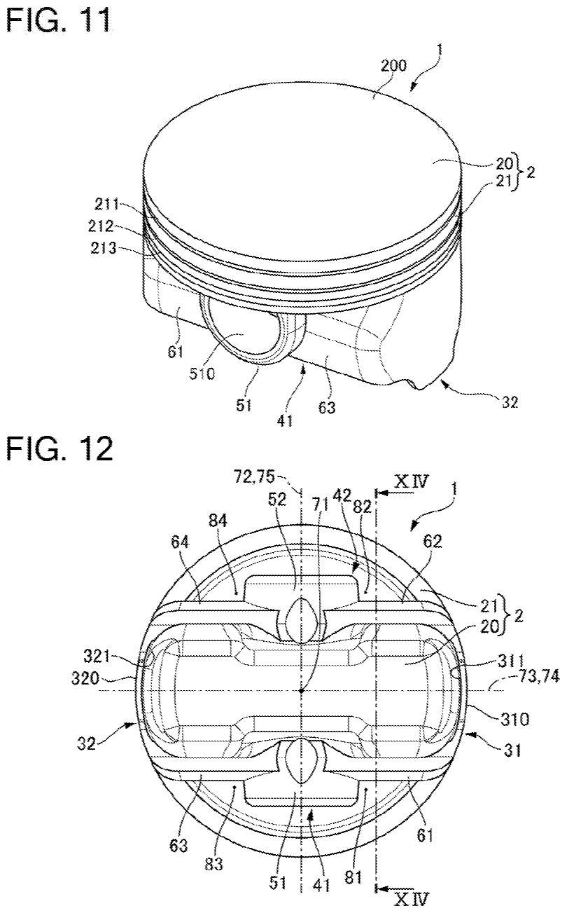

Only the points different from the first embodiment are described. As illustrated in FIG. 9, both ends of the skirt portion 31 in the circumferential direction each have a curved shape protruding in a direction of separating away from the reference plane 74 on both sides in the first axis direction across the intermediate portion 313. The skirt portion 32 also has the same shape.

As illustrated in FIG. 10, in the cross section 601 of the apron portion 61, the outer peripheral surface 610 and the inner peripheral surface 611 each have a curved shape on both sides in the first axis direction across the intermediate portion 613. The outer peripheral surface 610 includes an upper arc-shaped portion 614 and a lower arc-shaped portion 615. The upper arc-shaped portion 614 is located on one side in the first axis direction (side of the piston head portion 2) with respect to the intermediate portion 613. The lower arc-shaped portion 615 is located on another side in the first axis direction (side opposite to the piston head portion 2) with respect to the intermediate portion 613. Both of the arc-shaped portions 614 and 615 protrude in a direction of separating away from the reference plane 74. Both of the arc-shaped portions 614 and 615 have different curvature radii. A curvature radius of the upper arc-shaped portion 614 is larger than a curvature radius of the lower arc-shaped portion 615. The inner peripheral surface 611 also has the same shape.

In the cross section 601, as an angle of inclination of the outer peripheral surface 610 with respect to the reference plane 74, for example, with regard to the upper arc-shaped portion 614, there may be used an angle formed by a straight line, which passes through an end on one side in the first axis direction and a point of the intermediate portion 613, with respect to (a straight line parallel to) the reference plane 74. With regard to the lower arc-shaped portion 615, there may be used an angle formed by a straight line, which passes through an end on another side in the first axis direction and a point of the intermediate portion 613, with respect to (a straight line parallel to) the reference plane 74. Similarly to the first embodiment, the angle θ1 of the inclination on one side in the first axis direction with respect to the intermediate portion 613 is larger than the angle θ2 of the inclination on another side in the first axis direction with respect to the intermediate portion 613. This similarly applies to the inner peripheral surface 611. The apron portions 62 to 64 also have the same shape. Other configurations are the same as those of the first embodiment.

Next, actions and effects are described. In the cross section 601 of the apron portion 61, the outer peripheral surface 610 includes the upper arc-shaped portion 614 and the lower arc-shaped portion 615. As described above, when the shape of the outer peripheral surface 610 in the cross section 601 is formed into a curved shape, concentration of the stress in the apron portion 61 can be alleviated. Similarly, when the shape of the inner peripheral surface 611 in the cross section 601 is formed into a curved shape, concentration of the stress in the apron portion 61 can be alleviated.

The arc-shaped portions 614 and 615 have different curvature radii. With the combination of the portions having different curvature radii in the outer peripheral surface 610, the rigidity of the apron portion 61 can be optimized. This similarly applies to the inner peripheral surface 611.

Specifically, the arc-shaped portions 614 and 615 protrude in the direction of separating away front the reference plane 74. Accordingly, as compared to a case in which positions of the intermediate portion 613 and both ends in the first axis direction of the apron portion 61 are the same as those of this embodiment and in which the shape of the outer peripheral surface 610 in the cross section 601 is a linear shape, the width of the skirt portion 31 in the circumferential direction (distance 76) increases, thereby being capable of further reducing the hitting sounds of the piston 1.

The upper arc-shaped portion 614 is located on the side of the piston head portion 2 with respect to the intermediate portion 613. The lower arc-shaped portion 615 is located on a side opposite to the piston head portion 2 with respect to the intermediate portion 613. The curvature radius of the upper arc-shaped portion 614 is larger than the curvature radius of the lower arc-shaped portion 615. That is, a curvature of the upper arc-shaped portion 614 being the outer peripheral surface 610 defining the space portion 81 is relatively small. Therefore, in the case of molding the space portion 81 with a casting mold, the mold can easily be removed, thereby being capable of smoothly performing the mold removing step for the space portion 81.

Also with regard to the apron portions 62 to 64, the same actions and effects can be attained with the same configuration. Further, the same actions and effects as those of the first embodiment can be attained with the same configurations as the first embodiment.

### Third Embodiment

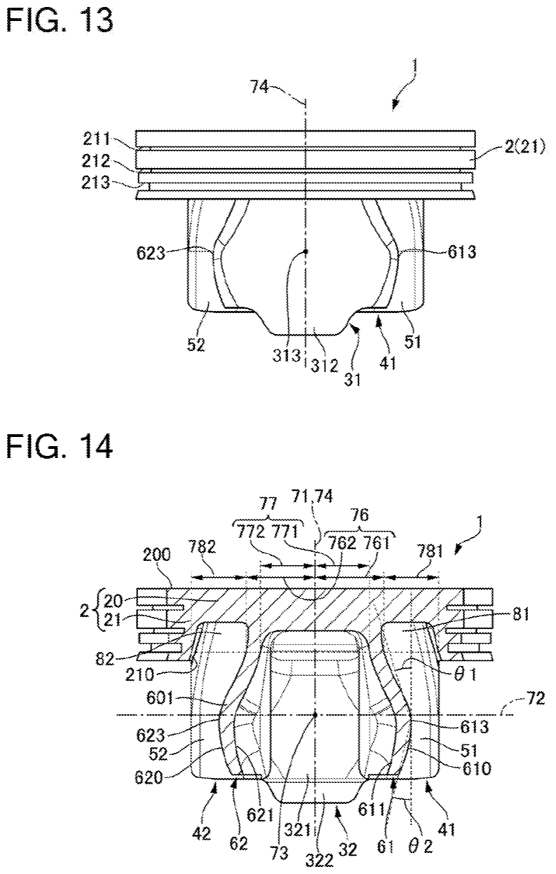

Only the points different from the second embodiment are described. As illustrated in FIG. 13, both ends of the skirt portion 31 in the circumferential direction each have a curved shape protruding in a direction of approaching the reference plane 74 on one side in the first axis direction (side of the piston head portion 2) with respect to the intermediate portion 313. The skirt portion 32 also has the same shape.

As illustrated in FIG. 14, in the cross section 601, the upper arc-shaped portion 614 of the outer peripheral surface 610 of the apron portion 61 protrudes in the direction of approaching the reference plane 74. This similarly applies to the inner peripheral surface 611. The apron portions 62 to 64 also have the same shape. Other configurations are the same as those of the second embodiment.

Next, actions and effects are described. In the cross section 601 of the apron portion 61, the upper arc-shaped portion 614 of the outer peripheral surface 610 protrudes in the direction of approaching the reference plane 74. Accordingly, the distance 781 (volume of the space portion 81) between the outer peripheral surface 610 of the apron portion 61 (upper arc-shaped portion 614) and the inner peripheral surface 210 of the land portion 21 in the second axis direction can be set larger. Also with regard to the apron portions 62 to 64, the same actions and effects can be attained with the same configuration. Further, the same actions and effects as those of the second embodiment can be attained with the same configurations as the second embodiment.

### Fourth Embodiment

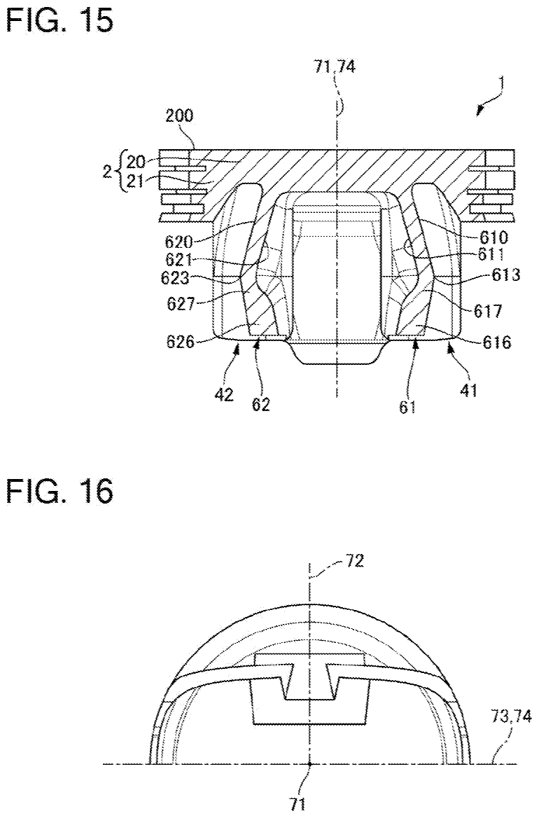

Only the points different from the first embodiment are described. As illustrated in FIG. 15, the apron portion 61 includes a rib portion 616. In the cross section 601, the rib portion 616 is a portion at which a thickness in the second axis direction is larger than that of any other part of the apron portion 61. The rib portion 616 projects toward the side of the reference plane 74 with respect to the inner peripheral surface 611 of the apron portion 61. The rib portion 616 extends in the third axis direction, and has one end connected to the pin boss portion 51 and another end connected to the skirt portion 31. The rib portion 616 is located on another side in the first axis direction (side opposite to the piston head portion 2) with respect to the intermediate portion 613, and is not provided at the intermediate portion 613 in the first axis direction and the vicinity thereof. The inner peripheral surface 611 of the rib portion 616 is inclined in the same direction as the outer peripheral surface 610 of the rib portion 616 with respect to the reference plane 74. Specifically, except for a connection portion (transition portion) 617 between the rib portion 616 and the other part, the inner peripheral surface 611 and the outer peripheral surface 610 of the rib portion 616 are substantially parallel to each other. The apron portions 62 to 64 also have the same shape. Other configurations are the same as those of the first embodiment.

Next, actions and effects are described. The apron portion 61 includes the rib portion 616 that is a portion at which the thickness in the second axis direction is larger than other parts. Accordingly, with the rib portion 616, excessive deformation of the skirt portion 31 can be more reliably suppressed. The rib portion 616 is not provided at the intermediate portion 613 in the first direction and the vicinity thereof. Therefore, flexure of the skirt portion 31 at the intermediate portion 313 and the vicinity thereof is not hindered by the rib portion 616. Accordingly, the effect of suppressing the hitting sounds of the piston 1 can be maintained.

Specifically, the rib portion 616 is located on the side opposite to the piston head portion 2 with respect to the intermediate portion 613 in the skirt portion 31. The side opposite to the piston head portion 2 with respect to the intermediate portion 313 is a free end that is not connected to the piston head portion 2, and hence is liable to be deformed. The deformation at this part can be effectively suppressed with the rib portion 616. Moreover, the rib portion 616 prevents the rigidity of the skirt portion 31 on the side connected to the piston head portion 2 from being excessively large, thereby being capable of maintaining the effect of suppressing the hitting sounds of the piston 1.

In the cross section 601 of the apron portion 61, the inner peripheral surface 611 of the rib portion 616 is inclined in the same direction as the outer peripheral surface 610 of the rib portion 616 with respect to the reference plane 74. The surfaces 610 and 611 of the rib portion 616 are inclined in the same direction, and hence a sharp change in thickness of the rib portion 616 in the second axis direction (thickness) is suppressed. Accordingly, stress concentration at the rib portion 616 can be suppressed. Specifically, the outer peripheral surface 610 and the inner peripheral surface 611 of the rib portion 616 are substantially parallel to each other. With this, a change in thickness of the rib portion 616 becomes smaller.

Also with regard to the apron portions 62 to 64, the same actions and effects can be attained with the same configuration.

The rib portion 616 of the apron portion 61 and the rib portion 626 of the apron portion 62 respectively project toward the side of the reference plane 74 with respect to the inner peripheral surfaces 611 and 621 of the apron portions 61 and 62. Accordingly, as compared to a case in which the rib portions 616 and 626 respectively project toward the side of separating away from the reference plane 74 with respect to the outer peripheral surfaces 610 and 620 of the apron portions 61 and 62, the distance 77 (support span of the skirt portion 31) between the inner peripheral surface 611 of the rib portion 616 and the inner peripheral surface 621 of the rib portion 626 in the second axis direction is shortened. Accordingly, the strength of the skirt portion 31 can be further improved. Also with regard to the apron portions 63 and 64, the same actions and effects can be attained with the same configuration. Further, the same actions and effects as those of the first embodiment can be attained with the same configurations as the first embodiment.

### Other Embodiments

The embodiments of the present invention have been described above with reference to the drawings. However, the specific configuration of the present invention is not limited to the configuration described in each of the embodiments. A change in design without departing from the scope of the gist of the invention is encompassed in the present invention. For example, a type of the engine is freely selected. The engine is not limited to the 4-stroke engine, and may be a 2-stroke engine. The engine is not limited to the gasoline engine, and may be a diesel engine. A method of supplying fuel may be of a direct injection type of directly injecting fuel into a cylinder (combustion chamber) or a port injection type of injecting fuel into an intake port. The engine is not limited to an engine mounted to a vehicle, and may be an engine mounted to, for example, a ship. A shape of the piston is freely selected. For example, in order to suppress so-called slapping noises, the second axis may be located slightly closer to the thrust side with respect to the first axis in the third axis direction. Moreover, the piston crown surface may have, for example, a recess for suppressing an interference with a valve.

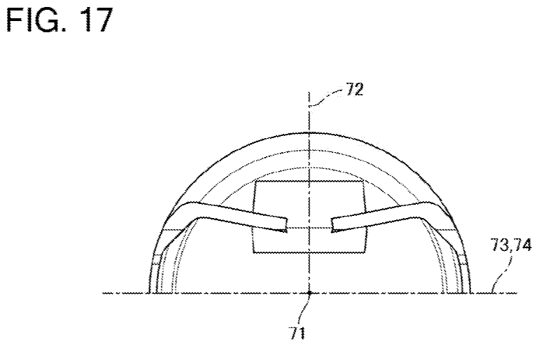

It is not always required that the apron portion linearly extend along the third axis. For example, as illustrated in FIG. 16, the shapes of the apron portions (and skirt portions) of the present invention may be applied to a piston including apron portions which expand radially outward. In the example illustrated in FIG. 16, as viewed from another side in the first axis direction, distances between the first reference plane 74 and the outer peripheral surface and the inner peripheral surface of the apron portion in the second axis direction gradually increases from the side of the skirt portion toward the side of the pin boss portion in the third axis direction. As illustrated in FIG. 17, the shapes of the apron portions (and the skirt portions) of the present invention may be applied to a piston in which the apron portions are recessed toward the radially inner side. In the example illustrated in FIG. 17, when viewed from another side in the first axis direction, the distances between the first reference plane 74 and the outer peripheral surface and the inner peripheral surface of the apron portion in the second axis direction gradually decreases from the side of the skirt portion toward the side of the pin boss portion in the third axis direction. In those examples, the outer peripheral surface and the inner peripheral surface of the apron portion may each have a linear shape or a curved shape when viewed from another side in the first axis direction. When the shapes of the apron portions (and the skirt portions) of the present invention are applied to the example of FIG. 17, the distance between (the outer peripheral surface of) the apron portion and (the inner peripheral surface of) the land portion in the second axis direction can be set larger, thereby being capable of further increasing the thickness reduction amount. Moreover, a distance between the pin boss portions which are opposed to each other in the second axis direction across the third axis 73 can be set sufficiently small around the center of the crown portion of the piston head. Accordingly, the strength of the crown portion can be further improved.

(Technical Ideas Understandable from Embodiments)

A description is now given of the technical idea (or technical solution; the same applies hereinafter) understandable from the embodiments described above.

(1) The piston for an internal combustion engine of the technical idea includes, in one mode:

a piston head portion having an annular piston ring groove;

a first skirt portion and a second skirt portion, which are a pair of piston skirt portions connected to the piston head portion; and

a first side-wall portion,

in which the first side-wall portion includes a first pin boss portion, and the first pin boss portion has a first piston pin hole into which a piston pin is inserted,

in which an axis that is orthogonal to a cross section of the piston head portion passing through an entire circumference of the piston ring groove and passes through a center of the cross section is set as a first axis,

in which an axis that is parallel to a longitudinal direction of the piston pin and passes through a center of a cross section of the piston pin orthogonal to the longitudinal direction of the piston pin is set as a second axis,

in which the first side-wall portion is located between the first skirt portion and the second skirt portion in a direction around the first axis,

in which, in a first side-wall cross section being a cross section of the first side-wall portion parallel to both of the first axis and the second axis, a distance between a reference plane, which is a plane that passes through the first axis and is orthogonal to the second axis, and an outer peripheral surface of the first side-wall portion in a direction of the second axis gradually increases from a side of the piston head portion toward a first intermediate portion, which is an intermediate portion of the first side-wall portion, in a direction of the first axis and gradually decreases from the first intermediate portion toward a side opposite to the piston head portion,

in which the piston further includes a second side-wall portion,

in which the second side-wall portion includes a second pin boss portion opposed to the first pin boss portion in the direction of the second axis, and the second pin boss portion has a second piston pin hole into which the piston pin is inserted,

in which the second side-wall portion is located between the first skirt portion and the second skirt portion in the direction around the first axis, and

in which, in a second side-wall cross section being a cross section of the second side-wall portion parallel to both of the first axis and the second axis, a distance between the reference plane and an outer peripheral surface of the second side-wall portion in the direction of the second axis gradually increases from the side of the piston head portion toward a second intermediate portion being an intermediate portion of the second side-wall portion in the direction of the first axis and gradually decreases from the second intermediate portion toward the side opposite to the piston head portion.

(2) in a more preferred mode, in the mode described above, the first intermediate portion and the second intermediate portion overlap with the first piston pin hole and the second piston pin hole in the direction of the first axis.
(3) In another preferred mode, in any one of the modes described above,

a width of the first skirt portion in the direction around the first axis gradually increases from the side of the piston head portion toward the first intermediate portion in the direction of the first axis and gradually decreases from the first intermediate portion toward the side opposite to the piston head portion, and

a width of the second skirt portion in the direction around the first axis gradually increases from the side of the piston head portion toward the second intermediate portion in the direction of the first axis and gradually decreases from the second intermediate portion toward the side opposite to the piston head portion.

(4) In still another preferred mode, in any one of the modes described above,

the piston head portion includes:
a plate-like portion extending in a direction orthogonal to the first axis; and
a tubular portion extending in the direction of the first axis and having the piston ring groove in an outer peripheral surface of the tubular portion,

a first space portion and a second space portion are defined in a region overlapping with the tubular portion and not overlapping with the plate-like portion in the direction of the first axis,

the first space portion is located between the tubular portion and the first side-wall portion in the direction of the second axis, and

the second space portion is located between the tubular portion and the second side-wall portion in the direction of the second axis.

(5) In still another more preferred mode, in any one of the modes described above,

the first intermediate portion is located on the side opposite to the piston head portion with respect to a point at a center of the first side-wall portion in the direction of the first axis, and

the second intermediate portion is located on the side opposite to the piston head portion with respect to a point at a center of the second side-wall portion in the direction of the first axis.

(6) In still another more preferred mode, in any one of the modes described above,

in the first side-wall cross section, the outer peripheral surface of the first side-wall portion has an arc shape protruding in a direction of separating away from the reference plane, and a curvature radius on the side of the piston head portion with respect to the first intermediate portion is larger than a curvature radius on the side opposite to the piston head portion with respect to the first intermediate portion, and

in the second side-wall cross section, the outer peripheral surface of the second side-wall portion has an arc shape protruding in the direction of separating away from the reference plane, and a curvature radius on the side of the piston head portion with respect to the second intermediate portion is larger than a curvature radius on the side opposite to the piston head portion with respect to the second intermediate portion.

(7) In still another more preferred mode, in any one of the modes described above,

in the first side-wall cross section, the outer peripheral surface of the first side-wall portion is inclined with respect to the reference plane, and an angle of the inclination on the side of the piston head portion with respect to the first intermediate portion is larger than an angle of the inclination on the side opposite to the piston head portion with respect to the first intermediate portion, and

in the second side-wall cross section, the outer peripheral surface of the second side-wall portion is inclined with respect to the reference plane, and an angle of the inclination on a side of the piston head portion with respect to the second intermediate portion is larger than an angle of the inclination on the side opposite to the piston head portion with respect to the second intermediate portion.

(8) In still another more preferred mode, in any one of the modes described above,

in the first side-wall cross section, the outer peripheral surface of the first side-wall portion includes a first arc-shaped portion having a first curvature radius, and

in the second side-wall cross section, the outer peripheral surface of the second side-wall portion includes a second arc-shaped portion having a second curvature radius.

(9) In still another more preferred mode, in any one of the modes described above,

in the first side-wall cross section, the outer peripheral surface of the first side-wall portion includes a third arc-shaped portion having a third curvature radius which is a curvature radius different from the first curvature radius, and

in the second side-wall cross section, the outer peripheral surface of the second side-wall portion includes a fourth arc-shaped portion having a fourth curvature radius which is a curvature radius different from the second curvature radius.

(10) In still another more preferred mode, in any one of the modes described above,

the first side-wall portion includes a first rib portion, and the first rib portion is a portion at which, in the first side-wall cross section, a thickness in the direction of the second axis is larger than other parts, and is located on the side opposite to the piston head portion with respect to the first intermediate portion, and

the second side-wall portion includes a second rib portion, and the second rib portion is a portion at which, in the second side-wall cross section, a thickness in the direction of the second axis is larger than other parts, and is located on the side opposite to the piston head portion with respect to the second intermediate portion.

(11) In other more preferred embodiment, in any one of the modes descried above,

in the first side-wall cross section, an inner peripheral surface of the first rib portion is inclined with respect to the reference plane in the same direction as an outer peripheral surface of the first rib portion, and

in the second side-wall cross section, an inner peripheral surface of the second rib portion is inclined with respect to the reference plane in the same direction as an outer peripheral surface of the second rib portion.

(12) In still another more preferred mode, in any one of modes described above,

in the first side-wall cross section, a distance between the reference plane and an inner peripheral surface of the first portion in the direction of the second axis gradually increases from the side of the piston head portion toward the first intermediate portion in the direction of the first axis and gradually decreases from the first intermediate portion toward the side opposite to the piston head portion, and

in the second side-wall cross section, a distance between the reference plane and an inner peripheral surface of the second side-wall portion in the direction of the second axis gradually increases from the side of the piston head portion toward the second intermediate portion in the direction of the first axis and gradually decreases from the second intermediate portion toward the side opposite to the piston head portion.

The present invention is not limited to the embodiments described above, and encompasses various modification examples. For example, the embodiments have described the present invention in detail for the ease of understanding, and the present invention is not necessarily limited to a mode that includes all of the configurations described above. A part of the configuration of one embodiment may be replaced with the configuration of another embodiment, and the configuration of one embodiment may be used in combination with the configuration of another embodiment. In each embodiment, another configuration may be added to, deleted from or replace a part of the configuration of each embodiment.

The present application claims a priority based on Japanese Patent Application No. 2017-181781 filed on Sep. 21, 2017. All disclosed contents including Specification, Scope of Claims, Drawings, and Abstract of Japanese Patent Application No. 2017-181781 filed on Sep. 21, 2017 are incorporated herein by reference in their entirety.

### REFERENCE SIGNS LIST

1 piston, 2 piston head portion, 20 crown portion (plate-like portion), 21 land portion (tubular portion), 211 to 213 piston ring groove, 31 first skirt portion, 32 second skirt portion, 51 first pin boss portion (first side-wall portion), 510 first piston pin hole, 52 second pin boss portion (second side-wall portion), 601 cross section (first side-wall cross section), 61 first apron portion (first side-wall portion), 610 outer peripheral surface, 611 inner peripheral surface, 613 intermediate portion (first intermediate portion), 614 upper arc-shaped portion (first arc-shaped portion), 615 lower arc-shaped portion (third arc-shaped portion), 616 rib portion (first rib portion), 62 second apron portion (second side-wall portion), 63 third apron portion (first side-wall portion), 64 fourth apron portion (second side-wall portion), 90 piston pin, 71 first axis, 72 second axis, 74 first reference plane, 81 space portion (first space portion)

1. A piston for an internal combustion engine, the piston comprising:
a piston head portion having an annular piston ring groove;
a first skirt portion and a second skirt portion, which are a pair of piston skirt portions connected to the piston head portion; and
a first side-wall portion,
wherein the first side-wall portion includes a first pin boss portion, and the first pin boss portion has a first piston pin hole into which a piston pin is inserted,
wherein an axis that is orthogonal to a cross section of the piston head portion passing through an entire circumference of the piston ring groove and passes through a center of the cross section is set as a first axis,
wherein an axis that is parallel to a longitudinal direction of the piston pin and passes through a center of a cross section of the piston pin orthogonal to the longitudinal direction of the piston pin is set as a second axis,
wherein the first side-wall portion is located between the first skirt portion and the second skirt portion in a direction around the first axis,
wherein, in a first side-wall cross section being a cross section of the first side-wall portion parallel to both of the first axis and the second axis, a distance between a reference plane, which is a plane that passes through the first axis and is orthogonal to the second axis, and an outer peripheral surface of the first side-wall portion in a direction of the second axis gradually increases from a side of the piston head portion toward a first intermediate portion, which is an intermediate portion of the first side-wall portion, in a direction of the first axis and gradually decreases from the first intermediate portion toward a side opposite to the piston head portion,
wherein the piston further includes a second side-wall portion,
wherein the second side-wall portion includes a second pin boss portion opposed to the first pin boss portion in the direction of the second axis, and the second pin boss portion has a second piston pin hole into which the piston pin is inserted,
wherein the second side-wall portion is located between the first skirt portion and the second skirt portion in the direction around the first axis, and
wherein, in a second side-wall cross section being a cross section of the second side-wall portion parallel to both of the first axis and the second axis, a distance between the reference plane and an outer peripheral surface of the second side-wall portion in the direction of the second axis gradually increases from the side of the piston head portion toward a second intermediate portion being an intermediate portion of the second side-wall portion in the direction of the first axis and gradually decreases from the second intermediate portion toward the side opposite to the piston head portion.

2. The piston for an internal combustion engine according to claim 1, wherein the first intermediate portion and the second intermediate portion overlap with the first piston pin hole and the second piston pin hole in the direction of the first axis.

3. The piston for an internal combustion engine according to claim 1,
wherein a width of the first skirt portion in the direction around the first axis gradually increases from the side of the piston head portion toward the first intermediate portion in the direction of the first axis and gradually decreases from the first intermediate portion toward the side opposite to the piston head portion, and
wherein a width of the second skirt portion in the direction around the first axis gradually increases from the side of the piston head portion toward the second intermediate portion in the direction of the first axis and gradually decreases from the second intermediate portion toward the side opposite to the piston head portion.

4. The piston for an internal combustion engine according to claim 1,
wherein the piston head portion includes:
a plate-like portion extending in a direction orthogonal to the first axis; and
a tubular portion extending in the direction of the first axis and having the piston ring groove in an outer peripheral surface of the tubular portion,
wherein a first space portion and a second space portion are defined in a region overlapping with the tubular portion and not overlapping with the plate-like portion in the direction of the first axis,
wherein the first space portion is located between the tubular portion and the first side-wall portion in the direction of the second axis, and
wherein the second space portion is located between the tubular portion and the second side-wall portion in the direction of the second axis.

5. The piston for an internal combustion engine according to claim 4,
wherein the first intermediate portion is located on the side opposite to the piston head portion with respect to a point at a center of the first side-wall portion in the direction of the first axis, and
wherein the second intermediate portion is located on the side opposite to the piston head portion with respect to a point at a center of the second side-wall portion in the direction of the first axis.

6. The piston for an internal combustion engine according to claim 5,
wherein, in the first side-wall cross section, the outer peripheral surface of the first side-wall portion has an arc shape protruding in a direction of separating away from the reference plane, and a curvature radius on the side of the piston head portion with respect to the first intermediate portion is larger than a curvature radius on the side opposite to the piston head portion with respect to the first intermediate portion, and
wherein, in the second side-wall cross section, the outer peripheral surface of the second side-wall portion has an arc shape protruding in the direction of separating away from the reference plane, and a curvature radius on the side of the piston head portion with respect to the second intermediate portion is larger than a curvature radius on the side opposite to the piston head portion with respect to the second intermediate portion.

7. The piston for an internal combustion engine according to claim 4,
wherein, in the first side-wall cross section, the outer peripheral surface of the first side-wall portion is inclined with respect to the reference plane, and an angle of the inclination on the side of the piston head portion with respect to the first intermediate portion is larger than an angle of the inclination on the side opposite to the piston head portion with respect to the first intermediate portion, and
wherein, in the second side-wall cross section, the outer peripheral surface of the second side-wall portion is inclined with respect to the reference plane, and an angle of the inclination on the side of the piston head portion with respect to the second intermediate portion is larger than an angle of the inclination on the side opposite to the piston head portion with respect to the second intermediate portion.

8. The piston for an internal combustion engine according to claim 1,
wherein, in the first side-wall cross section, the outer peripheral surface of the first side-wall portion includes a first arc-shaped portion having a first curvature radius, and
wherein, in the second side-wall cross section, the outer peripheral surface of the second side-wall portion includes a second arc-shaped portion having a second curvature radius.

9. The piston for an internal combustion engine according to claim 8,
wherein, in the first side-wall cross section, the outer peripheral surface of the first side-wall portion includes a third arc-shaped portion having a third curvature radius which is a curvature radius different from the first curvature radius, and
wherein, in the second side-wall cross section, the outer peripheral surface of the second side-wall portion includes a fourth arc-shaped portion having a fourth curvature radius which is a curvature radius different from the second curvature radius.

10. The piston for an internal combustion engine according to claim 1,
wherein the first side-wall portion includes a first rib portion, and the first rib portion is a portion at which, in the first side-wall cross section, a thickness in the direction of the second axis is larger than other parts, and is located on the side opposite to the piston head portion with respect to the first intermediate portion, and
wherein the second side-wall portion includes a second rib portion, and the second rib portion is a portion at which, in the second side-wall cross section, a thickness in the direction of the second axis is larger than other parts, and is located on the side opposite to the piston head portion with respect to the second intermediate portion.

11. The piston for an internal combustion engine according to claim 10,
wherein, in the first side-wall cross section, an inner peripheral surface of the first rib portion is inclined with respect to the reference plane in the same direction as an outer peripheral surface of the first rib portion, and
wherein, in the second side-wall cross section, an inner peripheral surface of the second rib portion is inclined with respect to the reference plane in the same direction as an outer peripheral surface of the second rib portion.

12. The piston for an internal combustion engine according to claim 1,
wherein, in the first side-wall cross section, a distance between the reference plane and an inner peripheral surface of the first side-wall portion in the direction of the second axis gradually increases from the side of the piston head portion toward the first intermediate portion in the direction of the first axis and gradually decreases from the first intermediate portion toward the side opposite to the piston head portion, and
wherein, in the second side-wall cross section, a distance between the reference plane and an inner peripheral surface of the second side-wall portion in the direction of the second axis gradually increases from the side of the piston head portion toward the second intermediate portion in the direction of the first axis and gradually decreases from the second intermediate portion toward the side opposite to the piston head portion.
